(19) United States
(12) Patent Application Publication
(10) Pub. No.: US 2010/0049438 A1
(43) Pub. Date: Feb. 25, 2010

(54) GPS DEVICE WITH VIDEO SECURITY FUNCTION AND METHOD THEREOF

(75) Inventors: HSIN-NAN HU, Tu-Cheng (TW); CHAO-FENG MA, Shenzhen City (CN); KUAN-HONG HSIEH, Tu-Cheng (TW); XIAO-GUANG LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/432,697

(22) Filed: Apr. 29, 2009

(30) Foreign Application Priority Data
Aug. 22, 2008 (CN) 200810304156.3

(51) Int. Cl. G01C 21/26

(52) U.S. Cl. 701/213

(57) ABSTRACT

This present disclosure provides a GPS device with a video security function and method for the same. The GPS device includes a communications unit to transmit communication data between the GPS device and at least one external video device, at least one motion sensing unit, the method includes steps of: detecting current motion state of a vehicle and obtaining sensing information; generating a first control signal to an external video device when a defined particular motion state is detected; transmitting the first control signal to turn on the video device through the communications unit; receiving the live feed provided by the video device; generating a second control signal to the video device, when the particular motion state is ended; and transmitting the second control signal to turn off the video device through the communication unit.

### BACKGROUND

1. Technical Field

The present disclosure relates to global positioning system (GPS) devices and, especially, to a GPS device having a video security function and a method for the video security function.

2. Description of Related Art

Usually, a vehicle navigation apparatus determines the current position of the vehicle using GPS data, and provides static information such as speed limits along chosen routes, gas station locations, known traffic speed monitoring locations etc. Sometimes, it is needed to view or analyze live feed of that time, for example, turning action, reversing, speeding, sudden acceleration, collision, turn over, being stolen and so on.

### BRIEF DESCRIPTION OF THE DRAWINGS

The components in the drawings are not necessarily drawn to scale, the emphasis instead being placed upon clearly illustrating the principles of the GPS device with video security function. Moreover, in the drawings, like reference numerals designate corresponding parts throughout the several views.

FIG. 1 is a block diagram of a hardware infrastructure of a GPS system with a video security function in accordance with an exemplary embodiment.

FIG. 2 is a block diagram of functional modules of a central processing unit (CPU) of FIG. 1, in accordance with an exemplary embodiment.

FIG. 3 is a flowchart of video security method implemented by the GPS device of FIG. 1, in accordance with an exemplary embodiment.

### DETAILED DESCRIPTION OF THE EMBODIMENTS

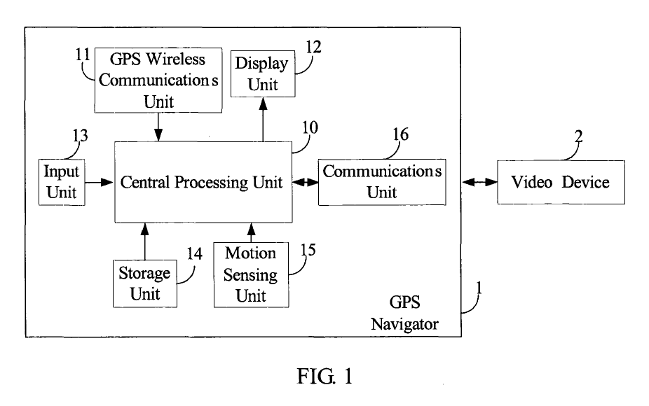

Referring to FIG. 1, GPS navigator 1 communicates with at least one external video device 2 through a communications unit 16. In order to make the disclosure clearer, only one video device 2 is taken for example in the following description. The communications unit 16 may be a wireless communications unit, such as one based on BLUETOOTH, and may alternatively be a wired communications unit, such as one based on the RS232 standard.

The video device 2 is configured to receive and execute control signals from the GPS navigator 1. The video device 2 may be any number of cameras needed to provide clear views for the driver. For example, a camera may be configured on the front of the vehicle, another on the rear of the vehicle, and yet another in the vehicle.

The GPS navigator 1 includes a central processing unit (CPU) 10, a GPS wireless communications unit 11, a display unit 12, an input unit 13, a storage unit 14, and a motion sensing unit 15.

The GPS wireless communications unit 11 is configured to receive GPS satellite navigation signals in real time, and transmit the navigation signals to the CPU 10. The input unit 13 is configured to receive user input operations.

The motion sensing unit 15 includes at least one sensor for sensing a current motion state of the vehicle, and generating a corresponding sensing signal for indicating the current motion state of the vehicle. The sensor may be, for example, but is not limited to, a vehicle speed sensor for detecting a vehicle speed, a gyroscope (GYRO) sensor for detecting an attitude of the body of the vehicle, a brake sensor for detecting an operation of the vehicle brake pedal by the driver, an emergency brake sensor for detecting an operation of a vehicle emergency brake by the driver, a throttle sensor for detecting throttle operation, a steering sensor for detecting steering operations, or a vertical acceleration sensor for detecting vertical acceleration of the vehicle.

The CPU 10 is configured to receive sensing signals from the motion sensing unit 15, and analyze the sensing signals to filter out noise and obtain sensing information. The CPU 10 is further configured to compare the sensing information with predetermined sensing parameters, therein the predetermined sensing parameters are divided into subsets, each subset contains one or more parameters associated with a particular motion state of the vehicle, for example, turning left, turning right, reversing, speeding, sudden acceleration, collision, turn over, being stolen and so on. When the sensing information satisfies the predetermined sensing parameters, namely the sensing information satisfies a subset of the predetermined sensing parameters or is in a predetermined range of one of the subsets of the predetermined sensing parameters, the CPU 10 may determine the current motion state of the vehicle accordingly.

When the current motion state of the vehicle is in a particular motion state, the CPU 10 further generates a first control signal, and transmits the first control signal to turn on an appropriate video device 2 through the communications unit 16. For example, when the vehicle crashes into another car, sensing acceleration value is in the predetermined range of one of the subsets of the predetermined sensing acceleration parameters, the CPU 10 determines the particular motion state of the vehicle is collision, generates a first control signal, and transmits the first control signal to turn on an appropriate video device 2 through the communications unit 16. In another example, a car is parked in a parking lot, the sensing information is the speed of the vehicle, and a predetermined speed parameter is 0 KM/H, when the sensing information, i.e., the current speed detected by the vehicle speed sensor, is over 0 KM/H, the CPU 10 determines a particular motion state of the vehicle is that it is being stolen, generates a first control signal, the communication unit 16 send the video signal to a remote security center so that security personal may give information of the criminal suspect and his actions to the police.

The CPU 10 continues to compare new sensing information with the predetermined sensing parameters. When the sensing information does not satisfy the predetermined sensing parameters, namely the vehicle is not in the particular motion state, the CPU 10 generates a second control signal to turn off the appropriate video device 2.

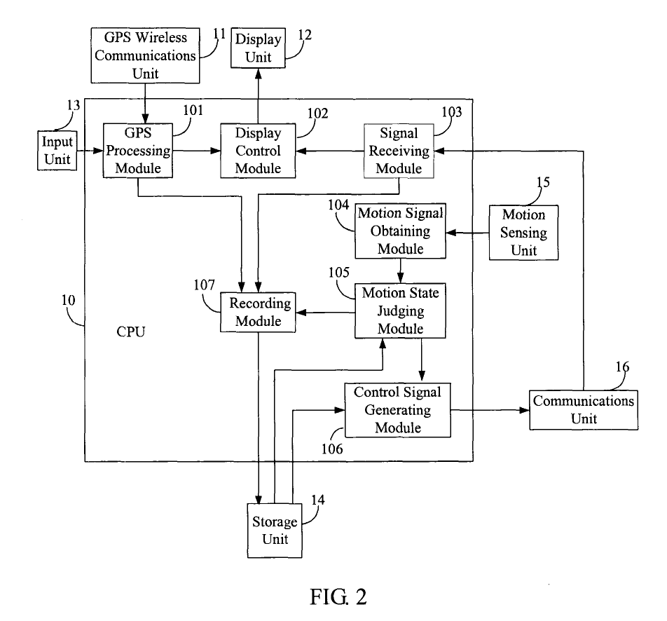

Referring to FIG. 2, the CPU 10 includes a GPS processing module 101, a display control module 102, a signal receiving module 103, a motion signal obtaining module 104, a motion state judging module 105, a control signal generating module 106, and a recording module 107.

The GPS processing module 101 is configured to determine navigation information according to the navigation signals from the GPS wireless communications unit 11 and the input information from the input unit 13. The navigation information includes, but is not limited to, the current position of the vehicle and the route. The display control module 105 automatically switches the display unit 12 to display the live feed when the live feed is received and switches back when the live feed ends. The signal receiving module 103 is configured to send the received live feed to the display control module 102 and the recording module 107.

The motion signal obtaining module 104 is configured to obtain the sensing signals which are detected from the motion sensing unit 15, filter out noise from the sensing signals to obtain sensing information of the motion sensing unit 15, and send the sensing information to the motion state judging module 105. The motion state judging module 105 is configured to compare the sensing information with the predetermined sensing parameters, determine a particular motion state when the sensing information satisfies a subset of the predetermined sensing parameters, and send the determined particular motion state to the control signal generating module 106 and the recording module 107.

The control signal generating module 106 is configured to generate and send control signals to turn on or turn off an appropriate video device 2 through the communications unit 16 according to the particular motion state. The recording module 107 is configured to save a particular state record which includes, but is not limited to, a current position obtained from the GPS processing module 101, a start time or an end time of the particular motion state, and the particular motion state from the motion state judging module 105. The storage unit 14 is configured to connect with the recording module 107, the motion state judging module 105 and the control signal generating module 106.

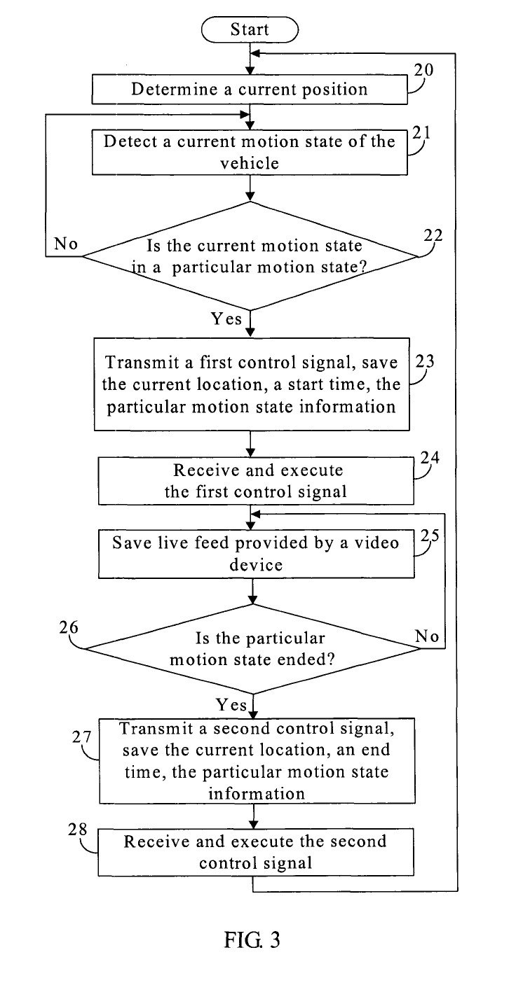

FIG. 3 is a flowchart of video security method implemented by the GPS device of FIG. 1.

In step 20, the GPS processing module 101 determines a current position of the vehicle according to the navigation signals which received by the GPS wireless communications unit 11. The GPS wireless communications unit 11 receives GPS satellite navigation signals in real time.

In step 21, the motion sensing unit 15 detects the current motion state of the vehicle and generates sensing signals, and sends the sensing signals to the motion signal obtaining module 104. The motion signal obtaining module 104 filters out noise from the sensing signals to obtain sensing information of the motion sensing unit 15, and sends the current sensing information to the motion state judging module 105.

In step 22, the motion state judging module 105 compares the sensing information with the predetermined sensing parameters, determines a particular motion state when the sensing information satisfies a subset of the predetermined sensing parameters, sends the determined particular motion state to the control signal generating module 106 and the recording module 107. When the motion state judging module 105 determines the current motion state isn't a particular motion state, the procedure returns to step 21.

In step 23, the control signal generating module 106 generates and sends a first control signal to turn on an appropriate video device 2. The recording module 107 obtains a current position of the vehicle from the GPS processing module 101, saves a particular state record in storage unit 14. The particular state record includes the current position, a start time of the particular motion state, and the particular motion state.

In step 24, the video device 2 is turned on in response to the first control signal, the signal receiving module 103 receives live feed provided by the video device 2 through the communications unit 16, and the display control module 102 switches the display unit 12 to display the live feed.

In step 25, the recording module 107 saves the live feed to the storage unit 14.

In step 26, when the sensing information does not satisfies the predetermined sensing parameters, namely the vehicle is not in the particular motion state, the motion state judging module 105 sends the judgment result to the control signal generating module 106 and the recording module 107. When the motion state judging module 105 determines the vehicle is still in the particular motion state, the procedure returns to the step 25.

In step 27, the control signal generating module 106 generates and sends a second control signal to turn off the appropriate video device 2 through the communications unit 16, the recording module 107 obtains the current position of the vehicle from the GPS processing module 101, saves the particular state record in the storage unit 14. The particular state record further includes the current position, an end time of the particular motion state, and the particular motion state.

In step 28, the video device 2 is turned off in response to the second control signal, the display control module 102 switches the display unit 12 to display the navigation information, and the procedure returns to the step 20.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the present invention.

What is claimed is:

1. A global position system (GPS) device with a video security function comprising:
a GPS wireless communications unit configured to receive GPS satellite navigation signals in real time;
a GPS processing module configured to determine navigation information according to the navigation signals from the GPS wireless communications unit;
a communications unit configured to transmit communication data between the GPS device and at least one external video device;
at least one motion sensing unit configured to obtain appropriate sensing signals at a current motion state;
a motion signal obtaining module configured to obtain the sensing signals which are detected from the motion sensing unit, and obtain sensing information from the sensing signals;
a motion state judging module configured to compare the sensing information with predetermined sensing parameters, and determine a particular motion state when the sensing information satisfies a subset of the predetermined sensing parameters;
a control signal generating module configured to generate and send control signals to an appropriate video device through the communications unit according to the particular motion state.

2. The GPS device as described in claim 1, further comprising a recording module, wherein the recording module configured to connect with a storage unit and save a particular state record to the storage unit, the storage unit being configured to connect with the motion state judging module and the control signal generating module, and the particular state record includes a current position obtain from the GPS processing module, a start time or an end time of the particular motion state and the particular motion state when the vehicle is in a particular motion state.

3. The GPS device as described in claim 2, further comprising a signal receiving module, wherein the signal receiving module configured to receive live feed which is transmitted through the communications unit, the particular state record further comprises the live feed.

4. The GPS device as described in claim 1, further comprising a display control module, wherein the display control module configured to switch the display unit to display the live feed when the live feed is received and switch back when the live feed ends.

5. A video security method used in a GPS device, the GPS device comprising a communications unit configured to transmit communication data between the GPS device and at least one external video device and at least one motion sensing unit, the method comprising:
detecting current motion state of a vehicle and obtaining sensing information;
generating a first control signal to an external video device when a defined particular motion state is detected;
transmitting the first control signal to turn on the video device through the communications unit;
receiving the live feed provided by the video device;
generating a second control signal to the video device, when the particular motion state is ended; and
transmitting the second control signal to turn off the video device through the communication unit.

6. The method as described in claim 5, further comprising:
saving a particular state record which includes a current position obtained from the GPS processing module, a start time of the particular motion state and the particular motion state, when determining the current motion state is in the particular motion state.

7. The method as described in claim 5, further comprising:
saving another particular state record which includes a current position obtained from the GPS processing module, an end time of the particular motion state and the particular motion state, when the particular motion state is ended.

8. The method as described in claim 5, further comprising:
switching to display live feed when the live feed is received and switching back when the live feed ends.
